(19) United States
(12) Patent Application Publication
(10) Pub. No.: US 2008/0070166 A1
(43) Pub. Date: Mar. 20, 2008

(54) Image sensor and method of forming the same

(75) Inventors: Byung-Jun Park, Yongin-si (KR); Chang-Rok Moon, Seoul (KR); Yun-Ki Lee, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/898,662

(22) Filed: Sep. 14, 2007

(30) Foreign Application Priority Data
Sep. 14, 2006 (KR) 10-2006-89323

(51) Int. Cl. G03C 5/00; G06K 9/20

(52) U.S. Cl. 430/321; 382/317

(57) ABSTRACT

One example embodiment may include an image sensor including a substrate, and a plurality of microlenses formed on the substrate. Each of the microlenses may include a base lens and a crosslinked overcoating film on a surface of the base lens.

### CLAIM OF PRIORITY

A claim of priority is made under 35 U.S.C §119 to Korean Patent Application 2006-89323 filed on Sep. 14, 2006, the disclosure of which is hereby incorporated by reference.

### FIELD

Example embodiments of the present invention may relate to an image sensor and methods of forming the same. In particular, example embodiments of the present invention may relate to an image sensor having a microlens and a method of forming the same.

### BACKGROUND

Generally, a microlens of an image sensor is manufactured by forming a photoresist pattern and reflowing the photoresist pattern. A photoresist pattern is reflowed to a desired thickness so that a surface of the photoresist pattern may have a desired curvature. A plurality of microlenses are formed by providing a plurality of photoresist patterns on a substrate at regular intervals and reflowing the photoresist patterns. The photoresist patterns generally have a tetragon (e.g., square) shape, but when the photoresist patterns are reflowed, they reflow into a circular shape. The circular photoresist patterns contact each other. However, there are dead spaces formed between adjacent photoresist patterns.

FIGS. 1A and 1B are top plan views illustrating a conventional microlens and a method of forming the same. FIGS. 2A and 2B are cross-sectional views taken along lines II-II′ of FIGS. 1A and 1B, respectively.

Referring to FIGS. 1A and 2A, a plurality of photoresist patterns 52 are formed on a substrate 50. The photoresist patterns 52 may have a square shape. Although not shown in the figures, a plurality of pixel regions are formed in the substrate 50 and arranged in a matrix to constitute a pixel array.

The photoresist pattern 52 is formed by exposing a photoresist (not shown) on the substrate 50. The photoresist patterns 52 are formed to have a desired thickness and disposed at regular intervals on the substrate 50. The photoresist patterns 52 are reflowed to form microlenses 60. The microlenses 60 are convex with a desired curvature.

Referring to FIGS. 1B and 2B, the substrate 50 including the photoresist patterns 52 is baked to reflow the photoresist patterns 52. The photoresist patterns 52 reflow in a circular manner to form the microlens 60.

As shown in the figures, the reflow of the photoresist pattern 52 is characterized in that more reflow occurs on a top surface than at an edge of the photoresist patterns 52. Hence, dead spaces DS may be defined between adjacent microlenses 60. Light impinging through the dead spaces DS may not be converged by a microlens 60, and may not reach a pixel region or the light may disperse to transmit crosstalk to a pixel.

A reflow time may be increased to overcome the foregoing problems. However, increasing the reflow time may distort a shape of the micolens 60, i.e., surface curvature of the microlens 60 may be lowered, which may lower the effectiveness of the micolens 60.

### SUMMARY

Example embodiments of the present invention may relate to an image sensor having a microlens and a method of forming the same. In an example embodiment, an image sensor may include a substrate, and a plurality of microlenses formed on the substrate. Each of the microlenses may include a base lens and a crosslinked overcoating film on a surface of the base lens.

In another example embodiment, a method of forming an image sensor may include forming a base lens on a substrate, forming an overcoating film on the base lens, forming a crosslinked overcoating film on a surface of the base lens by chemically reacting the overcoating film with the base lens, and removing non-reacted overcoating film.

In still another example embodiment, a method of forming an image sensor may include forming a photoresist layer on a substrate, forming a photoresist pattern, reflowing the photoresist pattern, forming an overcoating film on the photoresist pattern, mixing bake the overcoating film and the photoresist pattern to form a crosslinked overcoating film on a surface of the photoresist pattern, and removing non-reacted overcoating film.

### BRIEF DESCRIPTION OF THE DRAWINGS

FIGS. 1A and 1B are top plan views illustrating a conventional method of manufacturing a microlens;

FIGS. 2A and 2B are cross-sectional views taken along lines II-II′ of FIGS. 1A and 1B, respectively;

FIGS. 3A through 3E are top plan views illustrating a method of forming the microlens according to an example embodiment of the present invention;

FIGS. 4A through 4E are cross-sectional views taken along lines IV-IV′ of FIGS. 3A through 3E, respectively; and

FIG. 5 is a flowchart illustrating a method of forming a microlens according to an example embodiment of the present invention.

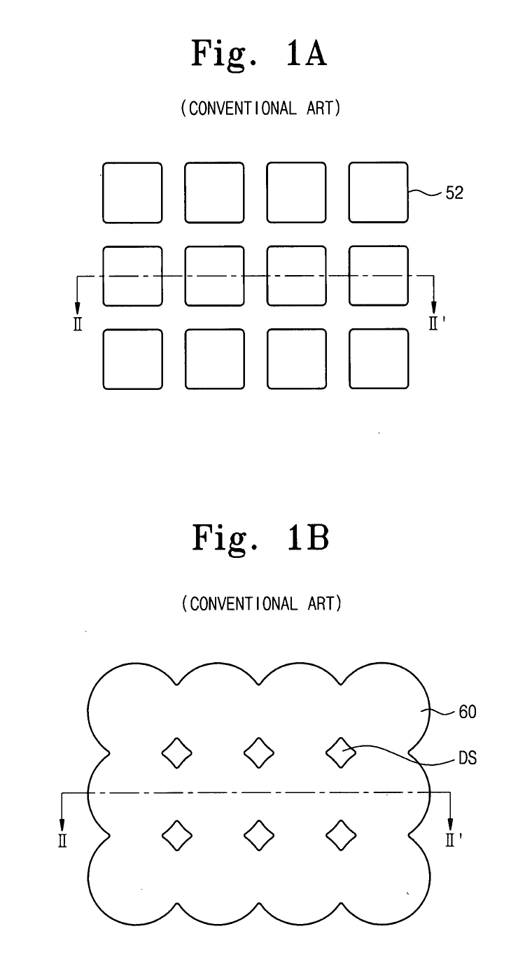

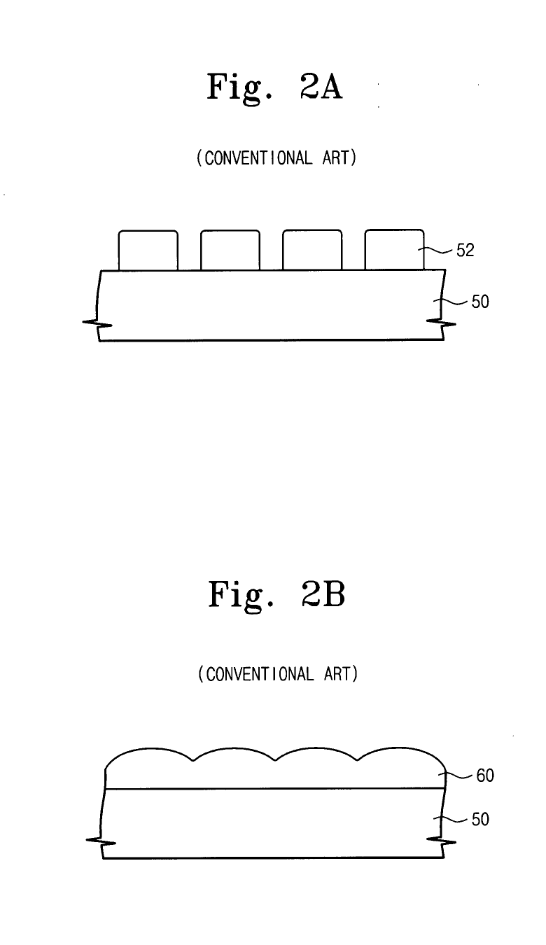

### DETAILED DESCRIPTION OF EXAMPLE EMBODIMENTS

Example embodiments of present invention will now be described more fully hereinafter with reference to the accompanying drawings, in which example embodiments are shown. Example embodiments, however, may be embodied in many different forms and should not be construed as limited to the example embodiments set forth herein. Rather, these example embodiments are provided so that this disclosure may be thorough, and will f convey the scope of the example embodiments to those skilled in the art.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there may be no intervening elements or layers present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be briented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-section illustrations that may be schematic illustrations of idealized embodiments (and intermediate structures). As such, variations from the shapes of the illustrations as a result, for example, of manufacturing techniques and/or tolerances, are to be expected. Thus, the example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to limit the example embodiments.

Unless otherwise defined, all terms (including technical and scientific terms) Used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

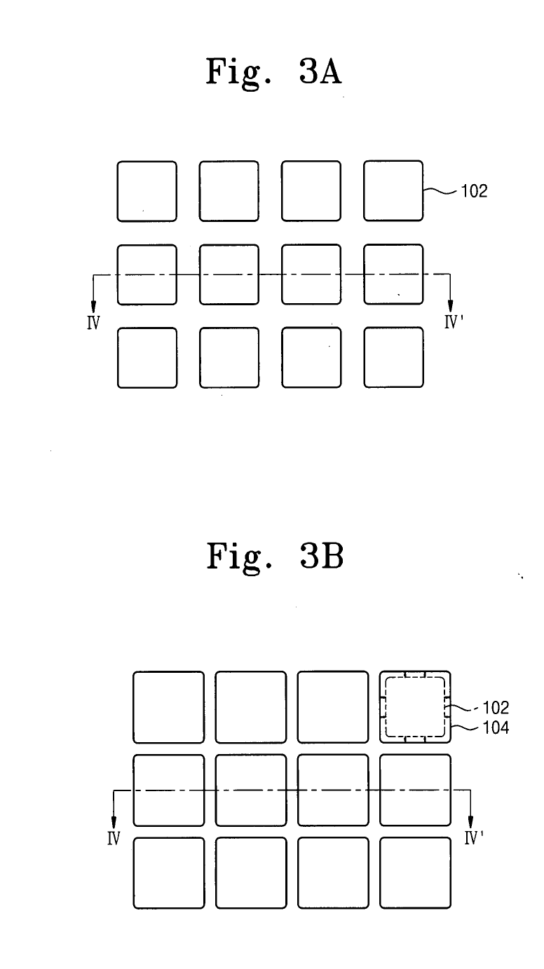

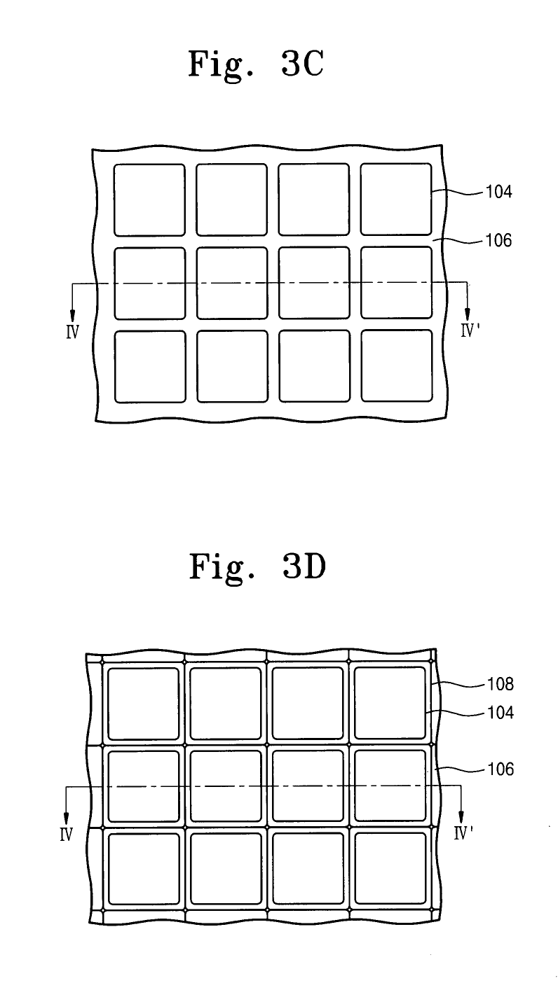

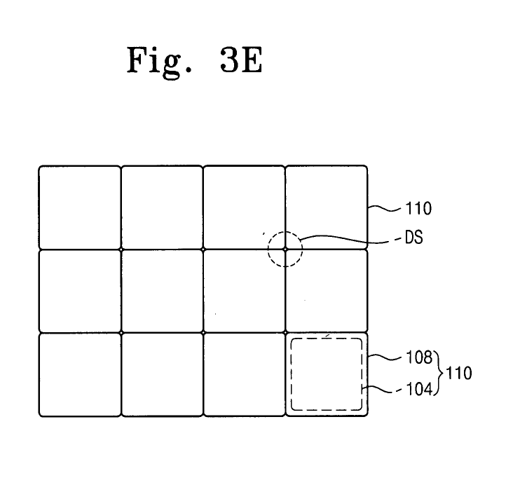

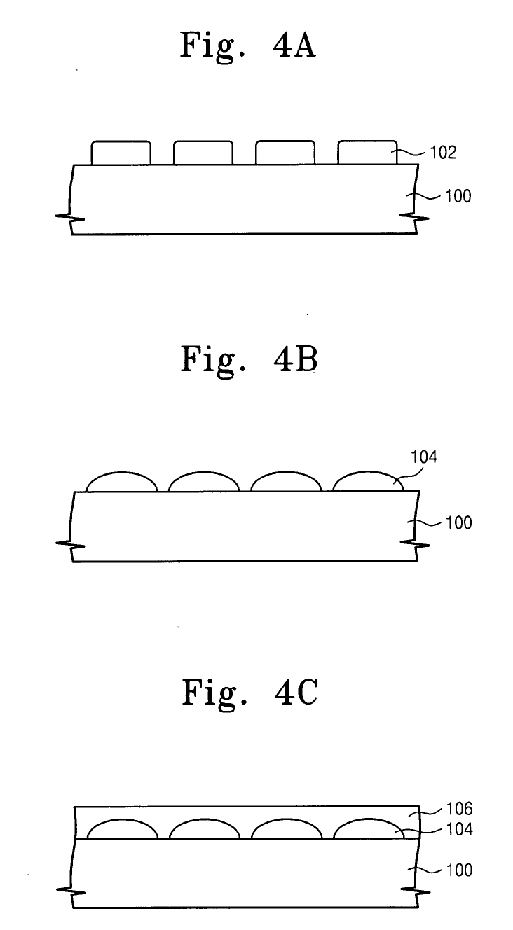

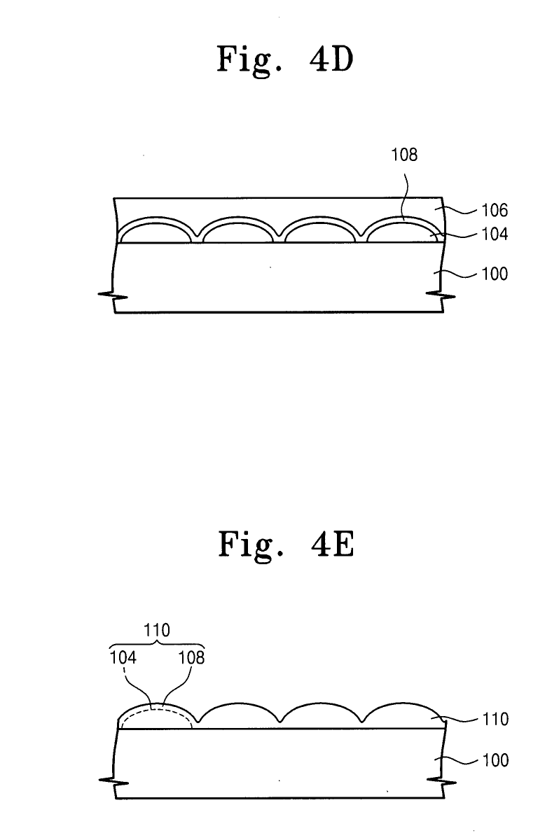

FIGS. 3A through 3E are top plan views illustrating a method of forming the microlens according to an example embodiment of the present invention, and FIGS. 4A through 4E are cross-sectional views taken along lines IV-IV′ of FIGS. 3A through 3E, respectively.

Referring to FIG. 3A and FIG. 4A, a lower layer 100 may be formed on a pixel region (not shown). A photoresist pattern 102 may be formed on the lower layer 100. Although not shown in the figures, a plurality of pixels may be arranged as a matrix-shaped array at a pixel region of an image sensor. The photoresist pattern 102 may be formed by a photolithography process. The photolithography process may include forming a photoresist layer (not shown) on the lower layer 100, exposing the resist layer, and then developing the resist layer. The photoresist pattern 102 may be formed to correspond to a pixel. A plurality of photoresist patterns 102 may be arranged on the lower layer 100 to constitute a pixel array. Each of the plurality of photoresist patterns 102 may have a desired thickness. In example embodiments, a thickness of the photoresist pattern 102 may be formed thinner than that of the conventional art. The plurality of photoresist patterns 102 may be arranged at regular intervals.

Referring to FIG. 3B and FIG. 4B, base lenses 104 may be formed by reflowing the plurality of photoresist patterns 102. The plurality of photoresist patterns 102 may be reflowed by baking at a desired temperature for a desired time. The bake temperature and time may be set so that the base lenses 104 do not contact each other after the reflow process.

The base lenses 104 may be formed via the reflow process to maintain a quadrangular shape, and the reflow process may increase a plane area of the base lenses 104. The quadrangular base lenses 104 may be spaced apart at regular intervals.

Referring to FIG. 3C and FIG. 4C, an overcoating film 106 may be formed on the quadrangular base lenses 104. The overcoating film 106 may be of a material which may chemically crosslink to the quadrangular base lenses 104. In other words, the overcoating film 106 binds with the quadrangular base lenses 104. The overcoating film 106 may be, for example, shrink assistant film for enhanced resolution (SAFIER) or resolution enhancement lithography assisted by chemical shrink (RELACS) film.

Referring to FIG. 3D and FIG. 4D, a mixing bake step may be performed on the resultant structure including the overcoating film 106. The mixing bake is a method of baking the resultant structure so that covercoating film 106 may crosslink with the quadrangular base lenses 104. Thus, a crosslinked overcoating film 108 may be formed on a surface of the quadrangular base lenses 104. The crosslinked overcoating film 108 may be chemically bonded to the quadrangular base lenses 104.

Photo acids may remain on the quadrangular base lenses 104 even after the exposure and development steps are completed. During the mixing bake step the photo acids and the overcoating film 106 may react (e.g., be chemically absorbed) at an interface between the quadrangular base lenses 104 and the overcoating film 106. The crosslinked overcoating film 108 on the surface of the quadrangular base lenses 104 may be formed to increase the size of base lenses 104.

Referring to a FIG. 3E and FIG. 4E, any non-reacted overcoating film 106 may be removed with a rinsing solution. As a result, a microlens 110 including the crosslinked overcoating film 108 and the quadrangular base lenses 104 may be formed. The overcoating film 106 may include a material that is soluble in a developing solution or a rinsing solution. However, the crosslinked overcoating film 108 may be transformed into a material that is not soluble in a developing solution or a rinsing solution.

The microlenses 110 may be manufactured with reduced number of dead spaces DS by increasing the size of the quadrangular base lenses 104. In the example embodiment, the dead spaces DS between the microlenses 110 may be reduced by controlling the shape of the quadrangular base lenses 104 and controlling a thickness of a portion crosslinked in the overcoating film 106. Thus, the microlenses 110 may be formed such that their sides come in contact with sides of adjacent microlenses 110 without forming relatively large dead spaces DS. In the case where the microlenses 110 are partially overlapped to reduce a space between the microlenses 110, the dead space DS may be removed.

In example embodiments, the microlens 110 may include the base lenses 104 and the crosslinked overcoating film 108 disposed on the lower layer 100. The microlens 110 may include a shape (quadrangular) formed by extending the shape of the photoresist pattern 102. By further increasing plane areas of the microlenses 110, the microlenses 110 may partially overlap each other to reduce dead spaces DS.

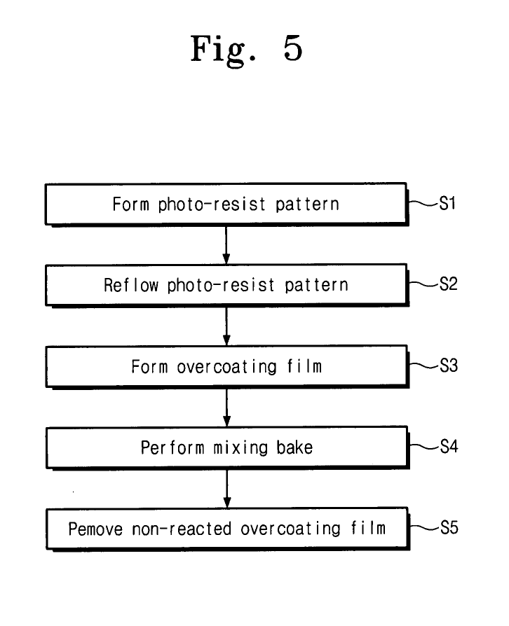

FIG. 5 shows a flow chart illustrating a method of forming an image sensor.

A photoresist layer may be formed on a lower layer 100. The lower layer 100 may be formed on a pixel region. A photoresist pattern 102 may be formed by a photolithography process in step S1.

The photoresist pattern 102 may be reflowed to form a base lenses 104 in step S2. The reflow temperature and the reflow time may be controlled to maintain a quadrangular shape of the base lenses 104.

An overcoating film 106 may be provided on a surface of the base lens in step S3.

A mixing bake process may be performed on the overcoating film 106 and the base lenses 104 in step S4. The mixing bake process may chemically cross-link the overcoating film 106 with a surface of the base lenses 104 to form a cross-linked overcoating film 108 on the surface of the base lenses 104.

Then, any remaining non-reacted overcoating film 106 may be removed a rinsing solution in step S5.

In the conventional art, a shape of a microlens may be distorted or the microlens may lose effectiveness due to an excessive reflow process. However, in the example embodiment, the lens shape may be maintained.

As disclosed above, dead spaces between microlenses may be reduced or removed without distortion or loss of lens shape. Moreover, since a photoresist pattern is reflowed to form a base lens and a size of the lens may be increased while keeping the shape of the base lens, the shape of a microlens may be controlled.

Although example embodiments have been described with the accompanying drawings, is the example embodiments are not limited thereto. It will be apparent to those skilled in the art that various substitutions, modifications and changes may be made without departing from the scope from of the example embodiments.

What is claimed is:

1. An image sensor comprising:
a substrate; and
a plurality of microlenses formed on the substrate,
wherein each of the microlenses includes a base lens and a crosslinked overcoating film on a surface of the base lens.

2. The image sensor of claim 1, wherein a shape of each of the microlenses is quadrangle, and each side of the microlens is in contact with a side of an adjacent microlens.

3. The image sensor of claim 1, wherein a plurality of base lenses are disposed on the substrate and spaced apart at regular intervals.

4. The image sensor of claim 1, wherein adjacent microlenses are in contact with each other.

5. The image sensor of claim 1, wherein the crosslinked overcoating film comprises at least one of shrink assistant film for enhanced resolution (SAFIER) and resolution enhancement lithography assisted by chemical shrink (RELACS) film.

6. The image sensor of claim 1, wherein the substrate is formed on a pixel region.

7. A method of forming an image sensor, comprising:
forming a base lens on a substrate;
forming an overcoating film on the base lens; and
forming a crosslinked overcoating film on a surface of the base lens by chemically reacting the overcoating film with the base lens.

8. The method of claim 7, wherein the forming the base lens comprises:
forming a photoresist layer on the substrate;
exposing the photoresist layer to form a photoresist pattern; and
reflowing the photoresist pattern.

9. The method of claim 8, wherein a plurality of photoresist patterns are formed on the substrate spaced apart at regular intervals.

10. The method of claim 7, wherein the base lens and the crosslinked overcoating film is chemically reacted by performing a mixing bake process.

11. The method of claim 10, wherein a temperature of the mixing bake process is about 140 to 150° C.

12. The method of claim 7, further comprising:
removing non-reacted overcoating film.

13. A method of forming an image sensor, comprising:
forming a photoresist layer on a substrate;
forming a photoresist pattern;
reflowing the photoresist pattern;
forming an overcoating film on the photoresist pattern; and
mixing bake the overcoating film and the photoresist pattern to form a crosslinked overcoating film on a surface of the photoresist pattern.

14. The method of claim 13, wherein forming the photoresist pattern comprises performing a photolithography process on the photoresist layer.

15. The method of claim 14, wherein a plurality of photoresist patterns are formed on the substrate spaced apart at regular intervals.

16. The method of claim 14, wherein the overcoating film comprises at least one of shrink assistant film for enhanced resolution (SAFIER) and resolution enhancement lithography assisted by chemical shrink (RELACS) film.

17. The method of claim 14, wherein a temperature of the mixing bake process is about 140 to 150° C.

18. The method of claim 13, further comprising:
removing non-reacted overcoating film.
